(19) United States
(12) Patent Application Publication
(10) Pub. No.: US 2007/0068421 A1
(43) Pub. Date: Mar. 29, 2007

(54) Silicone-based hard coating composition with middle and high refractive index, method of preparing the same, and optical lens prepared therefrom

(76) Inventors: Sang-Hyuk Im, Daejeon (KR); Do-Hyun Jin, Cheongju-shi (KR); Jong-Pyo Kim, Woolsan (KR); Seung-Heon Lee, Daejeon (KR); Young-Jun Hong, Daejeon (KR)

Correspondence Address: MCKENNA LONG & ALDRIDGE LLP, 1900 K STREET, NW, WASHINGTON, DC, 20006, US

(21) Appl. No.: 11/606,964

(22) Filed: Dec. 1, 2006

(30) Foreign Application Priority Data
Feb. 1, 2005 (KR) 10-2005-0116345
Oct. 19, 2006 (KR) 10-2006-0101915

(51) Int. Cl. C08G 77/14

(52) U.S. Cl. 106/287.16; 528/28

(57) ABSTRACT

The present invention relates to a silicone-based coating composition improved adhesion and dyeability, and more specifically, to a silicone-based coating composition prepared by adding a compound(s) having at least one functional group selected from the group consisting of amino, carboxylic acid, mercapto, methylol, anhydride, and isocyanate into an organic-inorganic sol prepared by a sol-gel reaction of organosilanes at high temperature, a method of preparing the same, and an optical lens prepared therefrom. The dyeability of the coating composition is improved by conducting sol-gel reaction at high temperature, and the adhesion to the substrate is improved by adding the compound capable of hydrogen bond and condensation reaction. Therefore, the coating layer of the present invention is proper to be applied to a coating layer for a plastic lens such as glasses, an industrial glass, or goggles for leisure because of good dyeability and adhesion to substrate.

### CROSS REFERENCES TO RELATED APPLICATION

This application claims priority to and the benefit of Korean Patent Application Nos. 10-2005-0116345 filed on Dec. 1, 2005, and 10-2006-0101915 filed on Oct. 19, 2006 in the Korean Industrial Property Office, and both of which are hereby incorporated by references for all purpose as if fully set forth herein.

### BACKGROUND OF THE INVENTION

(a) Field of the Invention

The present invention relates to a silicone-based coating composition with middle and high refractive index, which is excellent in adhesion and dyeing property and thus applicable to a coating layer of plastic lens such as optical lens, an industrial safety glass, or goggles for leisure, a method of preparing the same, and an optical lens prepared therefrom.

(b) Description of the Related Art

Plastic materials have merits of transparency, light weight, burst resistance, and good dyeability, and also it is easy to give various functions thereto. Therefore, the plastic lenses are being applied to optical lenses, especially, industrial glasses, and goggles for leisure.

However, the use of plastic materials for lenses is limited because the soft surface of the plastics can be easily scratched and cracked by impact.

In order to make up for the problem, coating compositions such as organic materials or silicon materials having good abrasion resistance are used for forming coating layers on the surface of the plastic lenses.

Many properties, such as good abrasion resistance, dyeability, solvent resistance, hot water resistance, adhesion property, gloss, transparency, and stability for work and storage, are demanded so that a coating composition is applied for plastic lenses. However, it is difficult to satisfy all of the properties in fact.

Korean Patent Publication No. 2000-0020026 discloses a coating composition including a sol-gel product of organosilane and zirconium alkoxide, and a multi-component inorganic oxide. However, the coating composition is poor in dyeing property and gloss, though the coating composition is good in impact resistance.

Korean Patent Publication No. 2002-0009786 discloses a siloxane-based coating composition including a sol-gel product of organosilane and zirconium alkoxide, and surface treated inorganic oxide having 3 or 4 components. In the publication, it is mentioned that the adhesion and storage stability of the composition can be enhanced by controlling the molecular weight of the sol-gel product by controlling the curing temperature and curing time. However, in fact, the dyeability of the coating layer prepared by the composition is poor, and some cracks appear on the surface of the coating layer during a hot water resistance test.

### SUMMARY OF THE INVENTION

In order to overcome the problems above, it is an aspect of the present invention to provide a silicone-based coating composition with middle and high refractive index, which is excellent in adhesion and dyeing property and thus applicable to a coating layer for a plastic lens such as an optical lens, an industrial safety glass, or goggles for leisure.

It is another aspect of the present invention to provide a method of preparing the silicone-based coating composition with middle and high refractive index.

Still another aspect of the present invention is to provide an optical lens including a coating layer prepared with the coating composition.

In order to attain these objects, the present invention provides a siloxane-based coating composition including:

a) 0.1 to 50 parts by weight of a compound(s) represented by the following Chemical Formula 1, a hydrolysate(s) thereof, or a partial condensate(s) thereof;

b) 10 to 60 parts by weight of a compound(s) represented by the following Chemical Formula 2, a hydrolysate(s) thereof, or a partial condensate(s) thereof;

c) 1.0 to 100 parts by weight of an inorganic oxide(s) having a refractive index of from 1.7 to 3.0;

d) 1.0 to 5 parts by weight of a compound(s) having at least one functional group capable of hydrogen bond and condensation reaction, selected from the group consisting of an amino, a carboxylic acid, a mercapto, a methylol, an anhydride, and an isocyanate;

e) 10 to 50 parts by weight of a complex compound(s) having at least one carbonyl group, and bonded with a C₁-C₁₂ alkyl or acetate; and

f) 10 to 130 parts by weight of a solvent(s).
R¹ₐ(SiOR²)₄₋ₐ Chemical Formula 1
R³_{b}Si(OR⁴)_{4-b} Chemical Formula 2

Wherein:

R¹ and R² are independently selected from the group consisting of a C₁-C₆ alkyl, a C₁-C₆ alkenyl, a C₁-C₆ halogenated alkyl, an allyl, and a C₃-C₆ aromatic group;

R³ is 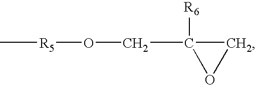
wherein R⁵ is a C₁-C₄ alkylene, and R⁶ is selected from the group consisting of hydrogen, a C₁-C₄ alkyl, and 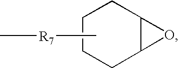
in which R⁷ is selected from the group consisting of hydrogen, a C₁-C₄ alkylene, and a C₁-C₄ alkyl;

R⁴ is a C₁-C₆ alkyl;

a is an integer from 0 to 3; and

b is an integer from 0 to 3.

Furthermore, the present invention provides a method of preparing a siloxane-based coating composition including the steps of:

a) preparing an organic-inorganic sol by mixing at least one compound represented by Chemical Formula 1, hydrolysates thereof, or partial condensates thereof and at least one compound represented by Chemical Formula 2, hydrolysates thereof, or partial condensates thereof in the presence of a solvent and a catalyst, and then conducting a sol-gel reaction at high temperature;

b) adding a complex compound(s) having at least one carbonyl group, and bonded with a C₁-C₁₂ alkyl or acetate into the organic-inorganic sol;

c) adding an inorganic oxide(s) having a refractive index of from 1.7 to 3.0 into the mixture solution prepared by step b); and

d) adding a compound(s) having at least one functional group capable of hydrogen bond and condensation reaction, selected from the group consisting of an amino, a carboxylic acid, a mercapto, a methylol, an anhydride, and an isocyanate into the mixture solution prepared by step c).

Furthermore, the present invention provides an optical lens including a coating layer(s) prepared from the coating composition and having a refractive index of from 1.5 to 1.65.

### DETAILED DESCRIPTION OF THE PREFERRED EMBODIMENTS

Hereinafter, the present invention is explained in more detail.

It is a distinctive technical feature of the present invention that the siloxane-based coating composition of the present invention is prepared by sol-gel reaction of organosilanes at a high temperature, and includes a compound(s) having at least one functional group capable of hydrogen bond and condensation reaction, selected from the group consisting of an amino, a carboxylic acid, a mercapto, a methylol, an anhydride, and an isocyanate, so as to enhance adhesion and dyeing property of the coating layer and apply to a coating layer of a plastic lens such as an optical lens, an industrial safety glass, or goggles for leisure.

The sol-gel reaction of organosilane is very complicated and the principle of the reaction is not revealed exactly. However, it is known that the properties of the organic-inorganic sol prepared by an acid catalyst are influenced by kinds of organosilane, kinds and concentration of acid catalyst, acidity (pH), temperature, concentration of water, kinds and concentration of alcohol, salts, etc. Specifically, the particle size and degree of aggregation of the prepared organic-inorganic sol and the number of functional groups of organosilane have an effect on abrasion resistance and dyeability of the prepared coating layer.

Generally, as the size of the prepared sol becomes smaller, the size of pores within the coating layer decreases and packing density of the coating layer increases. Therefore, it is necessary for enhancing dyeability that the size of pores within the coating layer are lager than the molecules of dyes, and thus the particle size of the sol of the present invention may be enlarged by sol-gel reaction at a high temperature.

The first organosilane of the present invention may be a compound(s) represented by the following Chemical Formula 1, a hydrolysate(s) thereof, or a partial condensate(s) thereof,
R¹ₐ(SiOR²)₄₋ₐ Chemical Formula 1

wherein:

R¹ and R² are independently selected from the group consisting of a C₁-C₆ alkyl, a C₁-C₆ alkenyl, a C₁-C₆ halogenated alkyl, an allyl, and a C₃-C₆ aromatic group; and

a is an integer from 0 to 3.

In said compound represented by Chemical Formula 1, when the subscript ‘a’ is 1 or more, it is most proper that R¹ is methyl. As the alkyl group of R¹ becomes longer, the softness of the coating layer increases and the properties of the prepared coating layer deteriorate.

The organosilane compound having the methyl group and the other organosilane compound having the other substituting group(s) can be used together as necessary. However, the moles of the organosilane having the methyl group(s) must be larger than the moles of the other organosilane compounds. Furthermore, when the subscript ‘a’ of the Chemical Formula 1 is 0, it is proper that R² is a C₁-C₆ alkyl.

More specifically, said compound represented by Chemical Formula 1 can be at least one compound selected from the group consisting of methyl trimethoxy silane, methyl triethoxy silane, vinyl trimethoxy silane, vinyl triethoxy silane, dimethyl dimethoxy silane, dimethyl diethoxy silane, vinyl methyl dimethoxy silane, butyl trimethoxy silane, diphenyl ethoxy vinyl silane, methyl triisopropoxy silane, methyl triacethoxy silane, tetraphenoxy silane, tetrapropoxy silane, and vinyl triisopropoxy silane.

The organosilane compound represented by Chemical Formula 1 may be included in the coating composition in an amount of from 0.1 to 50 parts by weight of the total composition, and more preferably from 1.0 to 15 parts by weight of the total composition. When the content of the organosilane compound is below this range, the abrasion resistance of the coating layer may be decreased, and, on the contrary, when the content of the organosilane compound is above this range, some cracks may appear on the surface of the coating layer during the hot water resistance test.

The second organosilane of the present invention may be a compound(s) represented by the following Chemical Formula 2, a hydrolysate(s) thereof, or a partial condensate(s) thereof,
R³_{b}Si(OR⁴)_{4-b} Chemical Formula 2

wherein:

R³ is 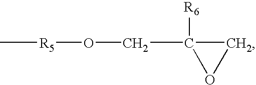
wherein R⁵ is a C₁-C₄ alkylene, and R⁶ is selected from the group consisting of hydrogen, a C₁-C₄ alkyl, and 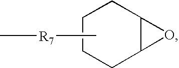
in which R⁷ is selected from the group consisting of hydrogen, a C₁-C₄ alkylene, and a C₁-C₄ alkyl;

R⁴ is a C₁-C₆ alkyl; and

b is an integer from 0 to 3.

The second organosilane compound represented by Chemical Formula 2 has an epoxy group(s) as a functional group, and thus the organosilane compound enables coloring or dyeing of the coating layer with an organic dye during hardening the coating composition of the present invention.

More specifically, said compound represented by Chemical Formula 2 can be at least one compound selected from the group consisting of 3-glycydoxy propyl trimethoxy silane, 3-glycydoxy propyl triethoxy silane, 3-glycydoxy propyl methylmethoxy silane, 3-glycydoxy propyl methylethoxy silane, and β-(3,4-epoxy cyclohexyl) ethyl trimethoxy silane.

The organosilane compound represented by Chemical Formula 2 may be included in the coating composition in an amount of from 10 to 60 parts by weight of the total composition, and more preferably from 20 to 40 parts by weight of the total composition. When the content of the organosilane compound is below this range, some cracks may appear on the surface of the coating layer during the hot water resistance test, and, on the contrary, when the content of the organosilane compound is above this range, the abrasion resistance of the coating layer may be decreased. Therefore it is preferable that the content of said organosilane compound represented by Chemical Formula 2 is controlled within the above range.

Sol-gel reaction of the organosilanes is proceeded by adding an acid catalyst, and several properties, such as stability of the siloxane-based coating composition and abrasion resistance of the coating layer, can be controlled by the catalyst which dominates the pH and the reaction speed.

The preferable example of the acid catalyst may be selected from the group consisting of acetic acid, phosphoric acid, sulfuric acid, chloric acid, nitric acid, chlorosulfonic acid, p-toluene sulfonic acid, trichloro acetic acid, polyphosphoric acid, iodic acid, iodic anhydride, and perchloric acid.

Said catalysts may be used alone or in combination with two or more of said compounds, considering the final pH of the coating composition, reaction speed classified by the ingredients of the coating composition, and adhesion property for applying to a substrate.

Furthermore, the present invention includes inorganic oxide with a predetermined content in order to exhibit middle and high refractive properties and to improve an abrasion property.

Said inorganic oxide has a refractive index of from 1.7 to 3.0, and more preferably may be a multi-component oxide(s) including two or more compounds selected from the group consisting of TiO₂ (refractive index: 2.5-2.7), SiO₂ (refractive index: 1.5), ZrO₂ (refractive index: 2.2), SnO₂ (refractive index: 2.0), Ce₂O₃ (refractive index: 2.2), BaTiO₃ (refractive index: 2.4), Al₂O₃ (refractive index: 1.73), and Y₂O₃ (refractive index: 1.92).

Said multi-component oxide(s) may be composed at adequate contents by their refractive index, and more preferably, at least one of TiO₂—ZrO₂—SnO₂, TiO₂—ZrO₂—SiO₂ and TiO₂—SnO₂—SiO₂ may be used.

Said inorganic oxide enables the refractive index of the coating layer prepared from the coating composition to be within the range of from 1.5 to 1.65, so as to give middle and high refractive properties to the coating layer.

It is preferable that the inorganic oxide maintains a stable dispersion state in the coating composition, therefore, it is preferable that the particle size of the inorganic oxide is from 5 nm to 30 nm with considering the transparency of the coating layer.

Said inorganic oxide may be included in the coating composition in an amount of from 1.0 to 100 parts by weight of the total composition, and more preferably from 10 to 70 parts by weight of the total composition. When the content of the inorganic oxide is below this range, it is difficult to prepare the coating layer having adequate refractive index, and, on the contrary, when the content of the inorganic oxide is above this range, the hardness of the coating layer is seriously deteriorated because the inorganic oxide may be a cracking spot and so the coating layer becomes cleaved or cracked. Therefore the content of said inorganic oxide may be controlled within the above range.

Especially, the coating composition of the present invention includes a compound(s) having at least one functional group being able to chemically bond with a substrate to improve adhesion property of the coating layer.

Said functional group of the compound may be at least one functional group capable of hydrogen bond and condensation reaction with good reactivity, selected from the group consisting of an amino(—NH₂), a carboxylic acid(C(═O)OH), a mercapto(—SH), a methylol(—CH₂OH), an anhydride(—C(═O)OC(═O)—), and an isocyanate(—N═C═O).

The compound having amino group may be at least one compound selected from the group consisting of ethylene diamine, diethylene triamine, trimethylene tetraamine, triethylene tetraamine, cyclo aliphatic isoprene diamine, m-phenylene diamine, 4,4-diamino diphenyl methane, 4,4-diamino diphenyl sulfone, dicyan diamide, a C₁-C₄ hydroxyl alkyl amine, a C₁-C₄ alkylamino silane, and a polyamide resin, and more preferably, may be selected from the group consisting of dicyan diamide, and a C₁-C₄ alkylamino silane.

The compound having carboxylic acid group may be at least one compound selected from the group consisting of itaconic acid, maleic acid, tartaric acid, and succinic acid.

The compound having mercapto group may be at least one compound selected from the group consisting of dimercaptosuccinic acid, 2,3-dimercapto-1-propanol, and 2,3-dimercapto-1-propanesulfonic acid.

The compound having methylol group may be at least one compound selected from the group consisting of phenol compound having methylol group, amino compound having methylol group, and urea compound having methylol group.

The compound having anhydride group may be at least one compound selected from the group consisting of maleic anhydride, phthalic anhydride, phthalic dianhydride, and hexahydro phthalic anhydride.

The compound having isocyanate group may be at least one compound selected from the group consisting of diphenyl methane diisocyanate (MDI), toluene diisocyanate (TDI), 1,6-hexamethylene diisocyanate (HDI), dicyan diamide, and isoprene diisocyanate (IPDI).

The compound having at least one functional group being able to chemically bond with a substrate may be included in the coating composition in an amount of from 0.1 to 5 parts by weight of the total composition, and more preferably from 0.5 to 3 parts by weight of the total composition. When the content of the compound is below this range, it is difficult to get a sufficient adhesion property to the substrate, and, on the contrary, when the content of the compound is above this range, the abrasion resistance of the coating layer gets worse. Therefore it is preferable that the content of the compound is controlled within the above range.

On the other hand, when the coating composition including the organo silanes is preserved for a long time, the coating composition may be aggregated and sticky, because of the condensation reaction of hydroxyl groups existing on the surface of the organic-inorganic sol. Therefore, the siloxane-based coating composition includes a complex compound(s) being capable of forming a chelate with the hydroxyl groups to enhance storage stability and workability of the coating composition.

The complex compound may form a chelate with a hydroxyl group (OH) existing on the surface of the organic-inorganic sol prepared by a sol-gel reaction, and it prevents aggregation of the organic-inorganic sol of the coating composition by inhibiting the condensation reaction between the hydroxyl groups of the sol.

The complex compound includes at least one carbonyl group, and is bonded with a C₁-C₁₂ alkyl or acetate. Specifically, said complex compound may be a ketone or a diketone compound, and more preferably may be at least one compound selected from the group consisting of acetyl acetone, acetone, methyl ethyl ketone, and 2,4-hexandion.

The complex compound may be included in the coating composition in an amount of from 10 to 50 parts by weight of the total composition, and more preferably from 20 to 30 parts by weight of the total composition. When the content of the complex compound is below this range, it is difficult to obtain a sufficient storage stability, and, on the contrary, when the content of the complex compound is above this range, the coated layer may be poorly dried and the coatability gets worse. Therefore the content of the complex compound may be controlled within the above range.

The siloxane-based coating composition of the present invention may be used by mixing with organic solvents such as alcohols, cellosolves, etc. The Examples of the mixing solvent are same to the examples of the solvent used in the sol-gel reaction of the organosilanes, and preferably the mixing solvent may include at least one solvent selected from the group consisting of methanol, ethanol, isopropanol, n-propanol, n-butanol, sec-butanol, t-butanol, methyl cellosolve, ethyl cellosolve, butyl cellosolve, ethyl acetate, methyl acetate, xylene, and toluene.

Said solvent may be used by mixing in an amount of from 10 to 130 parts by weight of the total composition, and more preferably 30 to 100 parts by weight of the total composition.

Furthermore, the siloxane-based coating composition may include a) a organic-inorganic sol prepared by sol-gel reaction of at least one compound represented by Chemical Formula 1, hydrolysates thereof, or partial condensates thereof, and at least one compound represented by Chemical Formula 2, hydrolysates thereof, or partial condensates thereof in the presence of a solvent and a catalyst, c) the inorganic oxide(s), d) the compound(s) having at least one functional group capable of hydrogen bond and condensation reaction, and e) the complex compound(s).

Furthermore, the siloxane-based coating composition of the present invention may further include various additives within a range not debasing the properties of the coating composition for the purpose of enhancing a adhesion to a substrate, workability, anti reflection property, etc.

The preferable examples of the additives are polyolefin-based epoxy resin, cyclohexane oxide, polyglycidyl esters, bisphenol A type epoxy resin, epoxy acrylate resin, or a UV absorber, such as a benzophenone-based compound, a benzotriazole-based compound, and a phenol-based compound.

Furthermore, various surfactants can be included in the coating composition for improving coatability, and the surfactant may be a block copolymer or a graft copolymer of dimethyl siloxane and polyether, or a fluorinated surfactant.

Hereinafter, the method for preparing the siloxane-based coating composition of the present invention is disclosed.

The method for preparing the siloxane-based coating composition of the present invention includes the steps of: a) preparing an organic-inorganic sol by mixing at least one compound represented by Chemical Formula 1, hydrolysates thereof, or partial condensates thereof and at least one compound represented by Chemical Formula 2, hydrolysates thereof, or partial condensates thereof in the presence of a solvent and a catalyst, and then conducting a sol-gel reaction at high temperature; b) adding a complex compound(s) having at least one carbonyl group, and bonded with a C₁-C₁₂ alkyl or acetate into the organic-inorganic sol; c) adding an inorganic oxide(s) having a refractive index of from 1.7 to 3.0 into the mixture solution prepared by step b); and d) adding a compound(s) having at least one functional group capable of hydrogen bond and condensation reaction, selected from the group consisting of an amino, a carboxylic acid, a mercapto, a methylol, an anhydride, and an isocyanate into the mixture solution prepared by step c).

More preferably, the compounds represented by Chemical Formula 1 and Chemical Formula 2 are mixed and then the sol-gel reaction is conducted in step a).

In this time, at least one solvent of alcohols and cellosolves, and more preferably, at least one solvent selected from the group consisting of methanol, ethanol, isopropanol, n-propanol, n-butanol, sec-butanol, t-butanol, methyl cellosolve, ethyl cellosolve, butyl cellosolve, ethyl acetate, methyl acetate, xylene, and toluene may be used in step a).

Especially, the sol-gel reaction of step a) may be conducted at a temperature of from 70 to 95° C. to raise the particle size of the prepared sol. The raised particles of the sol have stable molecule state because the compounds represented by Chemical Formulae 1 and 2 form 3-dimensional network structure, and the dyeability of the coating layer increases because the particles have some pores suitable for containing dyes.

The complex compound is added into the organic-inorganic sol in step b) at the same or similar temperature of sol-gel reaction without decreasing the reaction temperature.

In step c), the temperature of the sol-gel product of step b) is adjusted to a temperature of from 20 to 40° C. In this time, the inorganic oxide dispersed in the same solvent of the step a) can be added therein with considering the dispersibility and compatibility thereof.

In step d), the compound(s) having at least one functional group enable to improve adhesion property is added into the product of step c), and a reaction is conducted at a temperature of from 20 to 40° C.

As mentioned above, the coating layer prepared from the coating composition of the present invention has a refractive index of from 1.5 to 1.65, and thus the coating layer can be used as a middle and high refractive coating layer for various optical lenses, especially for plastic lenses such as industrial safety glasses or goggles for leisure to enhance qualities of the plastic lens.

Especially, the coating layer of the present invention has a good abrasion resistance, and shows good transparency of from 30 to 70% after dyeing as well as a good adhesion property measured by a hot water resistance test. Furthermore, the coating layer has high solvent resistance and dyeability, and discoloring after hardening does not occur.

Said coating layer can be prepared by coating the coating composition on a surface of an optical lens, specifically, a plastic lens such as an industrial safety glass or goggles for leisure, and by drying and hardening the coated composition, according to a common coating method.

The hardening condition after coating may be different in accordance with the mixing ratio or components of the coating composition. However, it is preferable to harden the coating layer at a temperature from 60 to 150° C., which is below the softening point of the substrate, for 20 minutes to 10 hours.

The coating method of the present invention is not particularly limited and a general wet coating process can be applied to the present invention, but it is preferable that any one process selected from roll coating, spray coating, dip coating, or spin coating is applied to the present invention.

The coating layer prepared from the coating composition may be dyed by dispersion dyes. In the dyeing process, the conditions such as concentration of the dye, temperature, and time may be freely determined, however it is preferable that the dyeing process is proceeded by dipping the coating layer into 0.1 to 1 weight % of aqueous dye solution at a temperature of from 80 to 100° C. for 5 to 10 minutes.

Hereinafter, the present invention is described in further detail through examples. However, the following examples are only for the understanding of the present invention and the present invention is not limited to or by them.

### EXAMPLE 1

(Preparation of a Coating Composition)

100 g of tetraethoxy silane, 250 g of 3-glycidoxy propyl trimethoxy silane, and 100 g of methanol were introduced in a jacket reactor maintaining room temperature and agitated for 5 minutes.

Subsequently, 80 g of aqueous acetic acid solution having pH 2.5 was added in the jacket reactor, and subjected to sol-gel reaction at 75° C. for 3 hours with agitating.

145 g of acetyl acetone was added in the sol solution prepared by the sol-gel reaction and then agitated the solution.

After lowering the temperature of the jacket reactor to 25° C., 350 g of TiO₂—SnO₂—ZrO₂ dispersion solution (made by Nissan Chemical Co., HIT-30M, diameter 5-20 nm, spherical, crystal phase, refractive index 2.3, solid content 30 wt %, dispersed in methanol) was added to the solution prepared by said sol-gel reaction. Subsequently, 40 g of itaconic acid was added into the solution and conducted a reaction for 1 hour with agitating to prepare a siloxane-based coating composition.

(Preparation of a Coating Layer)

After etching a high refractive lens for glasses (made by Chemiglass Co., MR-8, refractive index 1.59), said coating composition was coated on the lens by a dipping method, and hardened for 2 hours at 110° C. to produce a coating layer.

### EXAMPLE 2

The siloxane-based coating composition and the coating layer were prepared substantially according to the same method as Example 1, except that 40 g of itaconic acid was substituted with 20 g of dicyan amide and 20 g of itaconic acid.

### EXAMPLE 3

The siloxane-based coating composition and the coating layer were prepared substantially according to the same method as Example 1, except that 40 g of itaconic acid was substituted with 40 g of dicyan amide.

### COMPARATIVE EXAMPLE 1

(Preparation of a Coating Composition)

100 g of Tetraethoxy silane, 250 g of 3-glycidoxy propyl trimethoxy silane, and 100 g of methanol were introduced in a jacket reactor maintaining room temperature and agitated for 5 minutes. Subsequently, 80 g of aqueous acetic acid solution having pH 2.5 was added in the jacket reactor, and subjected to a sol-gel reaction at 25° C. for 3 hours with agitating.

145 g of acetyl acetone was added in the sol solution prepared by the sol-gel reaction and then agitated the solution.

Subsequently, 350 g of TiO₂—SnO₂—ZrO₂ dispersion solution (made by Nissan Chemical Co., HIT-30M, diameter 5-20 nm, spherical, crystal phase, refractive index 2.3, solid content 30 wt %, dispersed in methanol) was added into the solution prepared by the sol-gel reaction and agitated at 25° C. to prepare a siloxane-based coating composition.

(Preparation of a Coating Layer)

A coating layer was prepared substantially according to the same method of Example 1.

### COMPARATIVE EXAMPLE 2

The siloxane-based coating composition and the coating layer were prepared substantially according to the same method as Comparative Example 1, except that the sol-gel reaction was conducted at 75° C.

### EXPERIMENTAL EXAMPLE 1

### Testing Properties of the Siloxane-based Coating Composition

Storage stability of the siloxane-based coating compositions prepared by the Examples and Comparative Examples were tested and the results are listed in the following Table 1.

TABLE 1

| | | | | Comparative | Comparative |
|---|---|---|---|---|---|
| | Example 1 | Example 2 | Example 3 | Example 1 | Example 2 |
| Storage | ⊚ | ⊚ | ⊚ | ⊚ | ⊚ |
| stability | | | | | |

Viscosity and precipitation rate were evaluated after storing for 1 month at 25° C.
⊚: viscosity change of 1 cP or less, and precipitation rate of below 0.1%
◯: viscosity change of over 1 cP and 3 cP or less, and precipitation rate of 0.1% or more and below 0.5%
Δ: viscosity change of over 3 cP, and precipitation rate of 0.5% or more

Referring to above Table 1, all of the coating compositions prepared by Examples and Comparative Examples had good storage stability.

### EXPERIMENTAL EXAMPLE 2

### Testing Properties of the Coating Layers

The properties of the coating layers prepared by the Examples and Comparative Examples were tested according to the following Table 2, and the results as listed in the following Table 3.

TABLE 2

| | |
|---|---|
| Appearance | Appearance of the coating layer was observed existence and nonexistence of |
| | rainbow-colored interference with bare eyes after hardening. |
| Abrasion | Scratches of the coated lens were observed after rubbing the lens 30 times with |
| resistance | 0000 steel wool bound to a 1 kg hammer. |
| | 1. Not scratched: number of scratches is 0 |
| | 2. Slightly scratched: number of fine scratches of 1 cm or less is 3 or less, or |
| | number of long scratches of over 1 cm is 1 or less |
| | 3. Severely scratched: number of fine scratches of 1 cm or less is over 3, or number |
| | of long scratches of over 1 cm is over 1 |
| Adhesion property | According to ASTM D3359, the coating layer was divided into 100 sections of 1 mm × 1 mm, |
| | and an exfoliation test was conducted by using a cellophane tape of |
| | width 24 mm (Japan, Nichban Co.), 10 times. |
| | Adhesion property was determined by counting the number of sections that were |
| | not exfoliated. |
| Solvent resistance | The appearance of the coating layer was observed after rubbing the coating layer |
| | with a ball of cotton wetted with isopropyl alcohol and acetone 100 times. |
| Hot water | The coated high refractive lens (MR8: Chemiglass Co.) was dipped in boiling water |
| resistance | of 100° C. for 30 minutes, and appearance and adhesion tests were conducted. |
| Discoloration after | The color of the lens was observed with bare eyes after hardening. |
| hardening | |
| Dyeability | Transmittance of the coated lens was measured after dipping the lens into 0.2 wt % |
| | of aqueous BPI Sunbrown Dye solution (Brain Power Inc. co.) for 10 minutes at |
| | 90° C. |
| Refractive index | The coating composition was coated on a silicone wafer and then hardened. |
| | Refractive index was measured by using a prism coupler at five different points and |
| | the average thereof was calculated. |
| Hardness | The coating composition was coated on a a high refractive plat panel by a dipping |
| | method, and then hardness of the coating layer was measured by using pencil |
| | hardness tester under weight of 200 g. |

TABLE 3

| | | | | | Comparative | Comparative |
|---|---|---|---|---|---|---|
| | | Example 1 | Example 2 | Example 3 | Example 1 | Example 2 |
| Appearance | | No interference | No interference | No interference | No interference | No interference |
| Abrasion resistance | | 1 | 1 | 1 | 1 | 2 |
| Adhesion property | | 90/100 | 100/100 | 95/100 | 80/100 | 80/100 |
| Solvent resistance | | OK | OK | OK | OK | OK |
| Hot water | Appearance | OK | OK | OK | OK | OK |
| resistance | Adhesion | 80/100 | 100/100 | 95/100 | 50/100 | 70/100 |

| | | | | | |
|---|---|---|---|---|---|
| Discoloration after | No | No | No | No | No |
| hardening | | | | | |
| Dyeability (%) | 43% | 40% | 45% | 68% | 45% |
| Refractive index | 1.59 | 1.59 | 1.59 | 1.59 | 1.59 |
| Hardness | 8H | 8H | 8H | 8H | 6H |

Referring to the above Table 3, the coating layers prepared by Examples 1 to 3, in which the coating compositions prepared by sol-gel reaction at high temperature were used, showed hardness of 8 H, and also were good in the tests of appearance, abrasion resistance, solvent resistance, and hot water resistance.

Especially, the adhesion to the substrate was improved by using a compound capable of hydrogen bond and condensation reaction.

Furthermore, in the case of dyeability, the number means transmittance of light, and thus the dyeability is bad as the number of transmittance increases. Therefore, the coating layers prepared by Examples 1 to 3 showed good dyeability of 40 to 45%.

In the case of Comparative Example 1, the coating layer showed good results in all of abrasion resistance, solvent resistance, discoloring, and hardness. However, the coating layer was poor in the adhesion to the substrate, and it was not proper to a coating layer in view of the result of the hot water resistance test. Furthermore, the coating layer showed poor dyeability of 68%, which is not proper to a coating layer of an optical lens.

These results are due to that the dyes cannot be stably dispersed in the coating layer, because the size of particles of sol prepared by sol-gel reaction at low temperature is small and thus the size of pores within the coating layer is small too.

In the case of Comparative Example 2, the coating layer may be used for high refractive coating layer because it showed good dyeability and discoloring after hardening did not occurred. However, hardness of the coating layer was very low as 6H, and many scratches occurred on the surface of the coating layer in the abrasion resistance test. Furthermore, it is not proper to a coating layer of an optical lenses in view of low adhesion to substrate and low hot water resistance.

The difference of adhesion of the Examples and Comparative Examples is due to existence and nonexistence of the compound having at least one functional group capable of hydrogen bond and condensation reaction.

As mentioned above, the siloxane-based coating composition for middle and high refractive index of the present invention is great in storage stability, and the prepared coating layer has a good abrasion resistance and solvent resistance, and also discoloring after hardening does not occurred. Specifically, the coating layer of the present invention is proper to be applied to a coating layer for a plastic lens such as glasses, an industrial glass, or goggles for leisure because of good dyeability and adhesion to substrate.

Although the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A siloxane-based coating composition comprising
a) 0.1 to 50 parts by weight of a compound(s) represented by the following Chemical Formula 1, a hydrolysate(s) thereof, or a partial condensate(s) thereof;
b) 10 to 60 parts by weight of a compound(s) represented by the following Chemical Formula 2, a hydrolysate(s) thereof, or a partial condensate(s) thereof;
c) 1.0 to 100 parts by weight of an inorganic oxide(s) having a refractive index of from 1.7 to 3.0;
d) 1.0 to 5 parts by weight of a compound(s) having at least one functional group capable of hydrogen bond and condensation reaction, selected from the group consisting of amino, carboxylic acid, mercapto, methylol, anhydride, and isocyanate;
e) 10 to 50 parts by weight of a complex compound(s) having at least one carbonyl group, and bonded with a C₁-C₁₂ alkyl or acetate; and
f) 10 to 130 parts by weight of a solvent(s),
R¹ₐ(SiOR²)_{4-a,} Chemical Formula 1
R³_{b}Si(OR⁴)_{4-b,} Chemical Formula 2
wherein,
R¹ and R² are independently selected from the group consisting of a C₁-C₆ alkyl, a C₁-C₆ alkenyl, a C₁-C₆ halogenated alkyl, an allyl, and a C₃-C₆ aromatic group,
R³ is 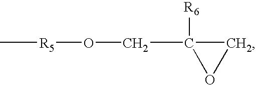
wherein R⁵ is a C₁-C₄ alkylene, and R⁶ is selected from the group consisting of hydrogen, a C₁-C₄ alkyl, and 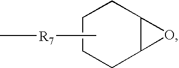
in which R⁷ is selected from the group consisting of hydrogen, a C₁-C₄ alkylene, and a C₁-C₄ alkyl;
R⁴ is a C₁-C₆ alkyl;
a is an integer from 0 to 3; and
b is an integer from 0 to 3.

2. The siloxane-based coating composition according to claim 1, wherein said compound represented by Chemical Formula 1 is at least one compound selected from the group consisting of methyl trimethoxy silane, methyl triethoxy silane, vinyl trimethoxy silane, vinyl triethoxy silane, dimethyl dimethoxy silane, dimethyl diethoxy silane, vinyl methyl dimethoxy silane, butyl trimethoxy silane, diphenyl ethoxy vinyl silane, methyl triisopropoxy silane, methyl triacethoxy silane, tetraphenoxy silane, tetrapropoxy silane, and vinyl triisopropoxy silane.

3. The siloxane-based coating composition according to claim 1, wherein said compound represented by Chemical Formula 2 is at least one compound selected from the group consisting of 3-glycydoxy propyl trimethoxy silane, 3-glycydoxy propyl triethoxy silane, 3-glycydoxy propyl methylmethoxy silane, 3-glycydoxy propyl methylethoxy silane, and β-(3,4-epoxy cyclohexyl) ethyl trimethoxy silane.

4. The siloxane-based coating composition according to claim 1, wherein said inorganic oxide is a multicomponent oxide(s) comprising two or more compounds selected from the group consisting of TiO₂, SiO₂, ZrO₂, SnO₂, Ce₂O₃, BaTiO₃, Al₂O₃, and Y₂O₃.

5. The siloxane-based coating composition according to claim 4, wherein said inorganic oxide is one or more multicomponent oxide selected from the group consisting of TiO₂—ZrO₂—SnO₂, TiO₂—ZrO₂—SiO₂ and TiO₂—SnO₂—SiO₂.

6. The siloxane-based coating composition according to claim 1, wherein said inorganic oxide has a particle size of from 5 nm to 30 nm.

7. The siloxane-based coating composition according to claim 1,
wherein said compound having amino group is at least one compound selected from the group consisting of ethylene diamine, diethylene triamine, trimethylene tetraamine, triethylene tetraamine, a cyclo aliphatic isoprene diamine, m-phenylene diamine, 4,4-diamino diphenyl methane, 4,4-diamino diphenyl sulfone, dicyan diamide, a C₁-C₄ hydroxyl alkyl amine, a C₁-C₄ alkylamino silane, and a polyamide resin;
said compound having carboxylic acid group is at least one compound selected from the group consisting of itaconic acid, maleic acid, tartaric acid, and succinic acid;
said compound having mercapto group is at least one compound selected from the group consisting of dimercaptosuccinic acid, 2,3-dimercapto-1-propanol, and 2,3-dimercapto-1-propanesulfonic acid;
said compound having methylol group is at least one compound selected from the group consisting of phenol compound having methylol group, amino compound having methylol group, and urea compound having methylol group;
said compound having anhydride group is at least one compound selected from the group consisting of maleic anhydride, phthalic anhydride, phthalic dianhydride, and hexahydro phthalic anhydride; and
said compound having isocyanate group is at least one compound selected from the group consisting of diphenyl methane diisocyanate (MDI), toluene diisocyanate (TDI), 1,6-hexamethylene diisocyanate (HDI), dicyan diamide, and isoprene diisocyanate (IPDI).

8. The siloxane-based coating composition according to claim 1, wherein said d) compound is at least one compound selected from the group consisting of ethylene diamine, dicyan diamide, alkylamino silane, itaconic acid, dimercaptosuccinic acid, amino formaldehyde, phthalic dianhydride, and 1,6-hexamethylene diisocyanate.

9. The siloxane-based coating composition according to claim 1, wherein said complex compound is at least one compound selected from the group consisting of acetyl acetone, acetone, methyl ethyl ketone, and 2,4-hexandion.

10. The siloxane-based coating composition according to claim 1, wherein said solvent is at least one solvent selected from the group consisting of methanol, ethanol, isopropanol, n-propanol, n-butanol, sec-butanol, t-butanol, methyl cellosolve, ethyl cellosolve, butyl cellosolve, ethyl acetate, methyl acetate, xylene, and toluene.

11. The siloxane-based coating composition according to claim 1, comprising organic-incorganic sol prepared by conducting sol-gel reaction of at least one compound represented by Chemical Formula 1, hydrolysates thereof, or partial condensates thereof, and at least one compound represented by Chemical Formula 2, hydrolysates thereof, or partial condensates thereof in the presence of a solvent and a catalyst; said c) inorganic oxide(s); said d) compound(s) having at least one functional group capable of hydrogen bond and condensation reaction; said e) complex compound(s).

12. A method of preparing a siloxane-based coating composition comprising the steps of:
a) preparing an organic-inorganic sol by mixing at least one compound represented by Chemical Formula 1, hydrolysates thereof, or partial condensates thereof and at least one compound represented by Chemical Formula 2, hydrolysates thereof, or partial condensates thereof in the presence of a solvent and a catalyst, and then conducting a sol-gel reaction at high temperature;
b) adding a complex compound(s) having at least one carbonyl group, and bonded with a C₁-C₁₂ alkyl or acetate into the organic-inorganic sol;
c) adding an inorganic oxide(s) having a refractive index of from 1.7 to 3.0 into the mixture solution prepared by step b); and
d) adding a compound(s) having at least one functional group capable of hydrogen bond and condensation reaction, selected from the group consisting of an amino, carboxylic acid, mercapto, methylol, anhydride, and isocyanate into the mixture solution prepared by step c),
R¹ₐ(SiOR²)_{4-a,} Chemical Formula 1
R³_{b}Si(OR⁴)_{4-b,} Chemical Formula 2
wherein,
R¹ and R² are independently selected from the group consisting of a C₁-C₆ alkyl, a C₁-C₆ alkenyl, a C₁-C₆ halogenated alkyl, an allyl, and a C₃-C₆ aromatic group,
R³ is 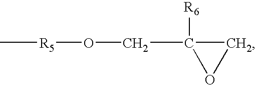
wherein R⁵ is a C₁-C₄ alkylene, and R⁶ is selected from the group consisting of hydrogen, a C₁-C₄ alkyl, and 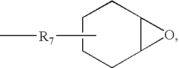
in which R⁷ is selected from the group consisting of hydrogen, a C₁-C₄ alkylene, and a C₁-C₄ alkyl,
R⁴ is a C₁-C₆ alkyl,
a is an integer from 0 to 3, and
b is an integer from 0 to 3.

13. The method of preparing a siloxane-based coating composition according to claim 12, wherein step a) and b) are conducted at a temperature of 70 to 95° C.

14. The method of preparing a siloxane-based coating composition according to claim 12, wherein step c) and d) are conducted at a temperature of 20 to 40° C.

15. The method of preparing a siloxane-based coating composition according to claim 12, wherein the catalyst is at least one acid selected from the group consisting of acetic acid, phosphoric acid, sulfuric acid, chloric acid, nitric acid, chlorosulfonic acid, p-toluene sulfonic acid, trichloroacetic acid, polyphosphoric acid, iodic acid, iodic anhydride, and perchloric acid.

16. The method of preparing a siloxane-based coating composition according to claim 12, wherein the inorganic oxide of step c) is a multicomponent oxide(s) comprising two or more compounds selected from the group consisting of TiO2, SiO₂, ZrO₂, SnO₂, Ce₂O₃, BaTiO₃, Al₂O₃, and Y₂O₃.

17. The method for preparing a siloxane-based coating composition according to claim 16, wherein said inorganic oxide is one or more multicomponent oxide selected from the group consisting of TiO₂—ZrO₂—SnO₂, TiO₂—ZrO₂—SiO₂ and TiO₂—SnO₂—SiO₂.

18. The method of preparing a siloxane-based coating composition according to claim 12, wherein the compound(s) added in step d) is at least one compound selected from the group consisting of ethylene diamine, dicyan diamide, alkylamino silane, itaconic acid, dimercaptosuccinic acid, amino formaldehyde, phthalic dianhydride, and 1,6-hexamethylene diisocyanate.

19. An optical lens comprising a coating layer(s) prepared from the coating composition of claim 1 and having a refractive index of from 1.5 to 1.65.

20. The optical lens according to claim 19, wherein the optical lens is an industrial safety glass or goggles for leisure.
